(19) United States
(12) Patent Application Publication
(10) Pub. No.: US 2008/0216513 A1
(43) Pub. Date: Sep. 11, 2008

(54) Method for the Regeneration of a Worn Quartz Glass Jig

(75) Inventors: Tatsuhiro Sato, Fukushima (JP); Akira Fujinoki, Fukushima (JP); Itsuo Araki, Kumamoto (JP)

Correspondence Address: TIAJOLOFF & KELLY, CHRYSLER BUILDING, 37TH FLOOR, 405 LEXINGTON AVENUE, NEW YORK, NY, 10174, US

(73) Assignees: Heraeus Quarzglas GmbH & Co. KG, Hanau (DE); Shin-Etsu Quartz Products Co., Ltd., Tokyo (JP)

(21) Appl. No.: 11/919,457

(22) PCT Filed: Apr. 27, 2006
(86) PCT No.: PCT/EP2006/061882

§ 371 Date: Nov. 30, 2007

(30) Foreign Application Priority Data
Apr. 28, 2005 (JP) 2005-132925

(51) Int. Cl. C03B 19/00; C03C 3/06

(52) U.S. Cl. 65/28

(57) ABSTRACT

To provide a technique with which a quartz glass jig and a doped quartz glass jig are regenerated by completely removing the impurities which are attached to the surface and the impurities which have diffused into the interior from quartz glass jigs which have been used in semiconductor production processes and then carrying out working repair and removing the contamination from the working processes as well. After use, the impurities are removed from the aforementioned quartz glass jigs in the said purification treatment process which includes a purification treatment process in which the quartz glass jigs are subjected to a purification treatment in a gaseous atmosphere which includes a halogen element at a temperature within the region above a prescribed temperature.

The invention concerns a method for the regeneration of a worn jig made of quartz glass (quartz glass jig) which is used in the semiconductor production process for example.

Conventionally, semiconductor devices such as MOSLSI and bipolar LSI have generally been produced by way of in excess of 500 processes such as oxidation processes, CVD processes and etching processes for example. A great number of semiconductor production devices are required for each process and quartz glass jigs are incorporated into these semiconductor production devices. Furthermore, these quartz glass jigs are dealt with as consumables and slight levels of damage are repaired in use, but those which have been consumed are scrapped and disposed of. Furthermore, more recently doped quartz glass jigs have come to be used in the etching processes in particular and the frequency of repair and regeneration has increased.

A method involving refusing and eliminating impurities with a flame treatment has been disclosed in Patent Citation 1 as a method for the regeneration of quartz glass jigs which have been used in a semiconductor production process.

Japanese Unexamined Patent Application Laid Open 2005-67997

### PROBLEMS TO BE SOLVED BY THE INVENTION

However, the problems outlined below are associated with the regeneration technique for quartz glass jigs and doped quartz glass jigs which have been used in the past.

The impurities which are attached to the quartz glass jigs in the semiconductor production process are not only present on the surface but also permeate into the fine cracks which are produced from the surface so that they are also present to a depth of at least 1 μm from the surface. The impurities which have permeated into these cracks are difficult to remove by means of ordinary cleaning and if the quartz glass jigs are repaired as they are with residual impurities using a flame treatment the cracks are closed and the impurities remain within the quartz glass forming foreign bodies or bubbles. Furthermore, Na, K, Cu and the like among the abovementioned impurities which have a high diffusion rate into quartz glass are thermally diffused into the whole of the thickness direction of the quartz glass, and those which have a somewhat lower diffusion rate, such as Fe for example, are thermally diffused to a few tens of μ from the surface.

Furthermore, the thickening of thin parts with fillets and welding are carried out by means of a flame process and a strain relieving anneal in the regeneration of quartz glass jigs and impurity contamination is produced. The working processes in which flames are used and the strain relieving anneal are essential parts of the repair process and the situation is such that the process contamination due to these processes cannot be avoided.

The present invention is based upon an understanding of these problems and it is intended to provide a technique for the regeneration of quartz glass jigs and doped quartz glass jigs with which, after removing completely the impurity attached to the surface and the impurity which has diffused into the jigs from quartz glass jigs which have been used in a semiconductor production process, working repairs are carried out and the contamination resulting from the working processes is also removed.

### MEANS OF SOLVING THESE PROBLEMS

In order to resolve the abovementioned problems, the method for the regeneration of quartz a glass jig of this invention is characterized that it includes a purification treatment, a repairing process and a cleaning treatment, whereby during the purification treatment the worn quartz glass jig is subjected to a gaseous atmosphere containing a halogen element at a temperature above a predetermined temperature, and during the repairing process worn parts of the quartz glass jig are repaired, and during the cleaning treatment the repaired quartz glass jig is cleaned.

After the purification treatment there is a repairing process in which the worn parts of the aforementioned the quartz glass jig are repaired and a cleaning treatment in which the quartz glass jig which has been subjected to the said repairing process is cleaned.

The aforementioned purification treatment process is preferably carried out in an atmosphere containing HCl gas at a temperature in the region from 400° C. to 1300° C. for from 1 minute to 400 hours.

Preferably, the quartz glass jig is made form doped quartz glass. Preferably, the repairing process involves at least one of the following treatments: fillet welding, an attachment of a pre-shaped glass sheet, a coating, a flame spray coating, each followed by a strain-relieving annealing treatment by using a flame process.

Doped quartz glass material can be used in the aforementioned repairing process.

The inclusion of from 0.1 to 20 wt % of metal element in the aforementioned doped quartz glass material is preferred. Furthermore, the metal element which is included in the aforementioned doped quartz glass material is preferably of two or more types, the said metal element comprising at least one type of first metal element selected from among group 3B of the periodic table and at least one type of second metal element selected from among Mg, Ca, Sr, Ba, Sc, Y, Ti, Zr, Hf, the lanthanides and the actinides.

The aforementioned cleaning treatment ideally includes at least one process selected from the group consisting of: heat treatment in a clean atmosphere, heat treatment in a gaseous atmosphere which contains a halogen element, cleaning by using a cleaning liquid.

The aforementioned purification treatment process preferably includes at least one more process selected from among the group of processes comprising processes involving heat treatment in a clean atmosphere, cleaning treatments involving cleaning liquids, and processes in which material attached to the surface is removed by burning with a flame.

In the aforementioned cleaning treatment or the aforementioned purification treatment process the aforementioned heat treatment in a clean atmosphere preferably involves maintaining a heating temperature of from 100° C. to 1300° C. in a gaseous atmosphere which contains oxygen for from 1 minute to 400 hours.

The regenerated quartz glass jig of this invention is a regenerated product which have been regenerated by means of the method for the regeneration of a quartz glass jig of this invention.

### EFFECT OF THE INVENTION

By means of the present invention it is possible to reuse worn out quartz glass jigs which have been used by semiconductor manufacturers as regenerated quartz glass jig products of high quality of which the impurity content is small by carrying out a high temperature halogen-containing gaseous atmosphere treatment.

### OPTIMUM EMBODIMENTS OF THE INVENTION

Embodiments of the invention are described below, but these are given as typical examples and of course various modifications can be applied provided that the technical concept of the invention is not exceeded.

The invention provides a method for the regeneration of a quartz glass jig which is characterized in that quartz glass jigs which have been used in a semiconductor production process can be subjected to a regenerating treatment with which impurities are removed by means of a heating purification treatment at a temperature above a prescribed temperature in a halogen-containing gaseous atmosphere and re-supplied to the user.

No particular limitation is imposed upon the aforementioned halogen-containing gaseous atmosphere provided that it is a gaseous atmosphere which contains a halogen element, and examples include HCl, HF, Cl₂, thionyl chloride and gaseous mixtures thereof, but HCl is preferred. This is because HCl gas is a stable gas which is effective for removing most metal impurities which is able to remove effectively, for example, Na, K, Li, Fe, Al, Ni, Cr, Cu and the like. A halogen-containing gaseous atmosphere is very effective for removing metal impurities which form low boiling point halides by means of a chemical reaction, such as Fe, Al, Ni, Cr and the like, in particular. The preferred treatment conditions for the aforementioned purification involve maintaining a temperature in the region of 400° C. to 1300° C. for from 1 minute to 400 hours.

The execution of a process involving heat treatment in a clean atmosphere, a process involving cleaning with a cleaning liquid and a process in which material attached to the surface is removed by burning, corresponding to the degree of contamination of the jigs which are subjected to the regeneration treatment, are preferably carried out in addition to the aforementioned heat treatment in a halogen-containing gaseous atmosphere in the aforementioned purification treatment process. Just one of these supplementary processes may be carried out, or a combination of two or more such processes may be carried out. No particular limitation is imposed upon the order of the various processes in the purification treatment process.

The removal of metal impurities which readily diffuse and migrate such as Na, K, Li, Cu and the like is carried out in the aforementioned heat treatment process in a clean atmosphere. No particular limitation is imposed upon the aforementioned clean atmosphere, but a gas which includes oxygen is preferred. This is because when the impurity is an organic material the impurity is oxidized and removed easily. The preferred heat treatment conditions involve maintaining a heating temperature within the range from 100° C. to 1300° C. for from 1 minute to 400 hours.

No particular limitation is imposed upon the aforementioned cleaning liquid, but hydrofluoric acid and ultra-pure water are preferred. The cleaning treatment with hydrofluoric acid and the like is carried out since it removes material which is attached to the surface and also opens up the very small cracks in the surface of the quartz glass jigs and readily removes impurities which have invaded these cracks.

The depth of the part of the quartz glass which is etched on cleaning with hydrofluoric acid and the like is preferably in the range of from 1 μm to 100 μm from the surface. This is because the depth to which the surface cracks penetrate is at the most from some 1 to 10μ and if the cracks are opened up to at least this depth then impurity removal is carried out very effectively. Furthermore, it is also because the depth of contamination to which the impurities in the semiconductor production processes and the repair working contamination with the metal impurities which are slow to diffuse is at the most a depth of 100 μm.

The aforementioned process in which material attached to the surface is burned off and removed with a flame has the best removal efficiency and is preferred in the case of organic impurities.

Both natural quartz glass jigs and synthetic quartz glass jigs can be used as the quartz glass jig with which the aforementioned regeneration treatment is carried out. Furthermore, it can also be applied to a doped quartz glass jig which have been doped with metal elements and the like.

In this invention the inclusion after the aforementioned purification treatment process of a repairing process in which parts of the quartz glass jig which have been worn out in the semiconductor production process are repaired and a final cleaning treatment is desirable.

No particular limitation is imposed upon the aforementioned method of repair and, for example 1. fillet welding repairs with a flame working treatment, 2. the attachment of thin moulds, 3. coating (application methods) and 4. flame coating methods can be used. In practical terms, for example, the techniques described in “Ceramic Coating” edited by Hiromi Takeda and published by the Nikkan Kogyo Shinbunsha and in “Fundamentals of Thin Film Formation”, written by Tachio Asamaki and published by the Nikkan Kogyo Shinbunsha Co. can be used.

If in those cases where the aforementioned flame working treatment is carried out the impurities are not removed beforehand by means of the aforementioned purification treatment process then foreign bodies and bubbles may be formed in the vicinity of the surface and the contamination may spread as a result of diffusion and migration of the metal impurities into the inner parts at high temperatures. By carrying out a purification treatment process of this invention it is possible to prevent impurity contamination and the formation of foreign bodies and bubbles to a marked extent. No particular limitation is imposed upon the flame working treatment method and known flame working treatments should be used. A stress relieving annealing treatment is preferably carried out after the flame working treatment.

The aforementioned attachment of a thin mould is a method in which a part of thickness some 1 to 5 mm is prepared beforehand as a thin mould of the part which has been worn away by normal plasma etching, the worn part of the quartz glass jig is ground away and the thin mould is fitted on.

The aforementioned coating and flame coating methods are procedures where a layer of quartz glass material is formed using these methods on the part of the quartz glass jig which has been worn away and then they are ground down to the prescribed shape by means of a grinding operation.

It is possible to produce doped quartz glass jigs by using doped quartz glass material in the aforementioned repairing process. In this case, natural quartz glass, synthetic quartz glass which has not been doped or doped quartz glass can be used for the quartz glass jig which is being repaired, but the use of natural or undoped synthetic quartz glass is preferred. By using natural or undoped synthetic quartz glass and arranging doped quartz glass material only in the parts where plasma etching resistance is required in a dry etching process it is possible to obtain doped quartz glass jigs which have excellent plasma resistance at low cost.

The total metal concentration in the aforementioned doped quartz glass material is preferably from 0.1 to 20 wt %. In the case of material which is to be used in a dry etching process in particular there is a need for plasma etching resistance and quartz glass which has the aforementioned doping concentration can provide a 10% to 200% improvement in plasma corrosion resistance.

The metal element included in the aforementioned doped quartz glass materials is preferably of two or more types, the said metal element comprising at least one type of first metal element selected from group 3B of the periodic table and at least one type of second metal element selected from among Mg, Ca, Sb, Ba, Sc, Y, Ti, Zr, Hf, the lanthanides and the actinides. The plasma corrosion resistance is increased further by doping with these metal elements and it can be increased by 20% to 400%.

The aforementioned final cleaning treatment is a process in which the working contamination which has been produced during the aforementioned repairing process is removed. The aforementioned cleaning treatment may be, for example, a process involving heat treatment in a clean atmosphere, a process involving heating and purification in a halogen-containing gaseous atmosphere or a cleaning treatment with a cleaning liquid. Any one of these processes or a combination of two or more of these processes is preferably carried out for the aforementioned final cleaning treatment. Each process is preferably carried out in the same way as the process involving heat treatment in a clean atmosphere, the process involving heating and purification in a halogen-containing gaseous atmosphere or the cleaning treatment with a cleaning liquid described as the aforementioned purification treatment processes.

It is possible to produce regenerated quartz glass jigs with no impurity contamination at all by following through all of the purification treatment process, the repairing process and the final cleaning treatment as described above.

### ILLUSTRATIVE EXAMPLES

The invention is described below in more practical terms by means of illustrative examples, but of course these illustrative examples are typical examples and they should not be interpreted as limiting the invention.

### Example 1

A quartz glass tube (diameter 300 mm×length 1500 mm×thickness 6 mm) which had been used by a semiconductor manufacturer to the worn surface of which a brown coloured foreign material was attached was taken and subjected to the treatment outlined below.

The aforementioned tube was immersed in 5% HF solution for 100 hours and then taken out and maintained in a 50% nitrogen and oxygen gas mixture of 5 nine purity at 800° C. for 5 hours, then it was maintained at 1200° C. for 1 hour in HCl gas of 5 nine purity and then cooled to room temperature and then taken out. (Process a: Purification treatment process)

Subsequently the worn thin part was subjected to a welding repair with flame working and it was then placed in an air atmosphere and maintained at 1100° C. for 2 hours and cooled to room temperature as a strain relieving anneal and then taken out. (Process b: Flame working treatment process)

Subsequently it was maintained in HCl gas of 5 nine purity at 1200° C. for 1 hour and cooled to room temperature and then taken out, and then it was immersed in 5% HF solution for 100 hours and taken out. (Process c: Final cleaning treatment)

The tube was subjected to surface analysis and bulk analysis after being taken (which is to say before treatment) and after each of the aforementioned treatment processes. The results are shown in Table 1. As shown in Table 1, the tube which had been subjected to the purification treatment maintained a state of very high purity. Moreover, it was a state where no foreign bodies, bubbles or the like were observed at all at the surface or in the vicinity of the surface.

TABLE 1
(Example 1)

| | | Metal Impurity | | | | | | | | |
|---|---|---|---|---|---|---|---|---|---|---|
| | Location of | Concentration (ppb) | | | | | | | | Foreign |
| | Analysis | Na | K | Li | Cu | Fe | Ni | Cr | Al | Matter |
| Before | Surface - 10 μm | 500 | 500 | 500 | 100 | 500 | 200 | 200 | 8000 | Yes |
| Treatment | 10-100 μm | 100 | 100 | 100 | 50 | 200 | 100 | 100 | 8000 | |
| | Bulk | 100 | 100 | 100 | 50 | 50 | 10 | 10 | 6000 | |
| After | Surface - 10 μm | 10 | 40 | 5 | 5 | 50 | 10 | 10 | 6000 | No |
| Process a | 10-100 μm | 10 | 40 | 5 | 5 | 50 | 10 | 10 | 6000 | |
| | Bulk | 10 | 40 | 5 | 5 | 50 | 10 | 10 | 6000 | |
| After | Surface - 10 μm | 100 | 100 | 50 | 30 | 100 | 20 | 20 | 7000 | No |
| Process b | 10-100 μm | 50 | 80 | 30 | 20 | 60 | 10 | 10 | 6000 | |
| | Bulk | 50 | 40 | 5 | 10 | 50 | 10 | 10 | 6000 | |
| After | Surface - 10 μm | 10 | 40 | 5 | 5 | 50 | 10 | 10 | 6000 | No |
| Process c | 10-100 μm | 10 | 40 | 5 | 5 | 50 | 10 | 10 | 6000 | |
| | Bulk | 10 | 40 | 5 | 5 | 50 | 10 | 10 | 6000 | |

In Table 1 as well as in the following tables the term “Foreign Matter” means and is including: adhered matter, bubbles or foreign bodies in the vicinity of the surface layer.

### Comparative Example 1

A quartz glass tube (diameter 300 mm×length 1500 mm×thickness 6 mm) which had been used by a semiconductor manufacturer to the worn surface of which a brown coloured foreign material was attached was taken and the worn thin part was subjected to a welding repair with flame working and it was then placed in an air atmosphere and maintained at 1100° C. for 2 hours and cooled to room temperature as a strain relieving anneal and then taken out. (Process b: Flame working treatment process)

When the tube was subjected to surface analysis and bulk analysis after treatment, very high metal impurity concentrations were confirmed. Furthermore foreign bodies and bubbles were observed at the surface and in the thickness in the vicinity of the surface. The results are shown in Table 2.

TABLE 2
(Comparative Example 1)

| | | Metal Impurity | | | | | | | | |
|---|---|---|---|---|---|---|---|---|---|---|
| | Location of | Concentration (ppb) | | | | | | | | Foreign |
| | Analysis | Na | K | Li | Cu | Fe | Ni | Cr | Al | Matter |
| Before | Surface - 10 μm | 500 | 500 | 500 | 100 | 500 | 200 | 200 | 8000 | Yes |
| Treatment | 10-100 μm | 100 | 100 | 100 | 50 | 200 | 100 | 100 | 8000 | |
| | Bulk | 100 | 100 | 100 | 50 | 50 | 10 | 10 | 6000 | |
| After | Surface - 10 μm | 300 | 400 | 200 | 50 | 400 | 150 | 150 | 7000 | Yes |
| Process b | 10-100 μm | 100 | 100 | 100 | 50 | 200 | 100 | 100 | 8000 | |
| | Bulk | 100 | 100 | 100 | 50 | 50 | 10 | 10 | 6000 | |

### Example 2

Similar results to those obtained in Example 1 were obtained on carrying out the same experiment as in Example 1 except that the conditions of the HCl gas treatment in the aforementioned purification treatment process and the final cleaning treatment were changed to maintaining at 500° C. for 30 hours.

### Example 3

Similar results to those obtained in Example 1 were obtained on carrying out the same experiment as in Example 1 except that the conditions of the HCl gas treatment in the aforementioned purification treatment process and the final cleaning treatment were changed to maintaining at 1250° C. for 10 minutes.

### Example 4

Similar results to those obtained in Example 1 were obtained on carrying out the same experiment as in Example 1 except that the conditions of the 50% gaseous mixture of oxygen and nitrogen treatment in the aforementioned purification treatment process were changed to maintaining at 200° C. for 300 hours.

### Example 5

Similar results to those obtained in Example 1 were obtained on carrying out the same experiment as in Example 1 except that the conditions of the 50% gaseous mixture of oxygen and nitrogen treatment in the aforementioned purification treatment process were changed to maintaining at 1250° C. for 10 minutes.

### Example 6

A worn 0.5 wt % Y and 1.0 wt % Al doped quartz glass ring (external diameter 300 mm×internal diameter 250 mm×thickness 6 mm) which had been used by a semiconductor manufacturer was taken and subjected to the treatment outlined below. The aforementioned ring was immersed in 5% HF solution for 100 hours and then taken out, then maintained in a 50% gaseous mixture of nitrogen and oxygen of 5 nine purity at 300° C. for 10 hours, then maintained in HCl gas of 5 nine purity at 1200° C. for 1 hour and then it was cooled to room temperature and taken out. Process a: Purification treatment process). Subsequently the worn thin part was fillet repaired using 0.5 wt % Y and 1.0 wt % Al doped quartz glass material with flame working and then placed in an air atmosphere and maintained at 1100° C. for 2 hours and cooled to room temperature for a strain relieving anneal and then it was taken out. (Process b: Flame working treatment process)

Subsequently it was maintained in HCl gas of 5.9 purity at 1200° C. for 1 hour and cooled to room temperature and taken out, and then it was immersed in 5% HF solution for 100 hours and then taken out. (Process c: Final cleaning treatment).

The ring was subjected to surface analysis and bulk analysis after being taken (which is to say before treatment) and after each of the aforementioned treatment processes. The results are shown in Table 3. As shown in Table 3, the ring which had been subjected to the purification treatment maintained a state of very high purity. Moreover, it was a state where no foreign bodies, bubbles or the like were observed at all at the surface or in the vicinity of the surface.

TABLE 3
(Example 6)

| | | | | | | | | Doped Metal | | |
|---|---|---|---|---|---|---|---|---|---|---|
| | | Metal Impurity | | | | | | Concentration | | |
| | Location of | Concentration (ppb) | | | | | | (ppm) | | Foreign |
| | Analysis | Na | K | Li | Cu | Fe | Ni | Y | Al | Matter |
| Before | Surface - 10 μm | 500 | 500 | 500 | 100 | 500 | 200 | 5000 | 10000 | No |
| Treatment | 10-100 μm | 100 | 100 | 100 | 50 | 200 | 100 | 5000 | 10000 | |
| | Bulk | 100 | 100 | 100 | 50 | 50 | 10 | 5000 | 10000 | |
| After | Surface - 10 μm | 10 | 40 | 5 | 5 | 50 | 10 | 5000 | 10000 | No |
| Process a | 10-100 μm | 10 | 40 | 5 | 5 | 50 | 10 | 5000 | 10000 | |
| | Bulk | 10 | 40 | 5 | 5 | 50 | 10 | 5000 | 10000 | |
| After | Surface - 10 μm | 100 | 100 | 50 | 30 | 100 | 20 | 5000 | 10000 | No |
| Process b | 10-100 μm | 50 | 80 | 30 | 20 | 60 | 10 | 5000 | 10000 | |
| | Bulk | 50 | 40 | 5 | 10 | 50 | 10 | 5000 | 10000 | |
| After | Surface - 10 μm | 10 | 40 | 5 | 5 | 50 | 10 | 5000 | 10000 | No |
| Process c | 10-100 μm | 10 | 40 | 5 | 5 | 50 | 10 | 5000 | 10000 | |
| | Bulk | 10 | 40 | 5 | 5 | 50 | 10 | 5000 | 10000 | |

### Example 7

A similar experiment to Example 6 was carried out except that the worn inner diameter of the ring was removed by a grinding process and a process where a thin moulded 0.5 wt % Y 1.0 wt % Al doped quartz glass ring (external diameter 260 mm×internal diameter 250 mm×thickness 3 mm) was attached was carried out instead of the aforementioned flame working treatment process. The results are shown in Table 4.

TABLE 4
(Example 7)

| | | | | | | | | Doped Metal | | |
|---|---|---|---|---|---|---|---|---|---|---|
| | | Metal Impurity | | | | | | Concentration | | |
| | Location of | Concentration (ppb) | | | | | | (ppm) | | Foreign |
| | Analysis | Na | K | Li | Cu | Fe | Ni | Y | Al | Matter |
| Before | Surface - 10 μm | 500 | 500 | 500 | 100 | 500 | 200 | 5000 | 10000 | No |
| Treatment | 10-100 μm | 100 | 100 | 100 | 50 | 200 | 100 | 5000 | 10000 | |
| | Bulk | 100 | 100 | 100 | 50 | 50 | 10 | 5000 | 10000 | |
| After | Surface - 10 μm | 10 | 40 | 5 | 5 | 50 | 10 | 5000 | 10000 | No |
| Process a | 10-100 μm | 10 | 40 | 5 | 5 | 50 | 10 | 5000 | 10000 | |
| | Bulk | 10 | 40 | 5 | 5 | 50 | 10 | 5000 | 10000 | |
| After | Surface - 10 μm | 100 | 100 | 50 | 30 | 100 | 20 | 5000 | 10000 | No |
| Process b | 10-100 μm | 50 | 80 | 30 | 20 | 60 | 10 | 5000 | 10000 | |
| | Bulk | 50 | 40 | 5 | 10 | 50 | 10 | 5000 | 10000 | |
| After | Surface - 10 μm | 10 | 40 | 5 | 5 | 50 | 10 | 5000 | 10000 | No |
| Process c | 10-100 μm | 10 | 40 | 5 | 5 | 50 | 10 | 5000 | 10000 | |
| | Bulk | 10 | 40 | 5 | 5 | 50 | 10 | 5000 | 10000 | |

### Example 8

A similar experiment to Example 6 was carried out except that a worn normal natural quartz glass ring (external diameter 300 mm×internal diameter 250 mm×thickness 6 mm) which had been used by a semiconductor manufacturer was used instead of the doped quartz glass ring. The results are shown in Table 5.

TABLE 5
(Example 8)

| | | | | | | | | Doped Metal | | |
|---|---|---|---|---|---|---|---|---|---|---|
| | | Metal Impurity | | | | | | Concentration | | |
| | Location of | Concentration (ppb) | | | | | | (ppm) | | Foreign |
| | Analysis | Na | K | Li | Cu | Fe | Ni | Y | Al | Matter |
| Before | Surface - 10 μm | 500 | 500 | 500 | 100 | 500 | 200 | 0 | 10 | No |
| Treatment | 10-100 μm | 100 | 100 | 100 | 50 | 200 | 100 | 0 | 10 | |
| | Bulk | 100 | 100 | 100 | 50 | 50 | 10 | 0 | 10 | |
| After | Surface - 10 μm | 10 | 40 | 5 | 5 | 50 | 10 | 0 | 10 | No |
| Process a | 10-100 μm | 10 | 40 | 5 | 5 | 50 | 10 | 0 | 10 | |
| | Bulk | 10 | 40 | 5 | 5 | 50 | 10 | 0 | 10 | |
| After | Surface - 10 μm | 100 | 100 | 50 | 30 | 100 | 20 | 5000 | 10000 | No |
| Process b | 10-100 μm | 50 | 80 | 30 | 20 | 60 | 10 | 5000 | 10000 | |
| | Bulk | 50 | 40 | 5 | 10 | 50 | 10 | 5000 | 10000 | |
| After | Surface - 10 μm | 10 | 40 | 5 | 5 | 50 | 10 | 5000 | 10000 | No |
| Process c | 10-100 μm | 10 | 40 | 5 | 5 | 50 | 10 | 5000 | 10000 | |
| | Bulk | 10 | 40 | 5 | 5 | 50 | 10 | 5000 | 10000 | |

### Comparative Example 2

A worn 0.5 wt % Y and 1.0 wt % Al doped quartz glass ring (external diameter 300 mm×internal diameter 250 mm×thickness 6 mm) which had been used by a semiconductor manufacturer was taken and the part which had worn thin part was subjected to a welding repair using doped quartz glass material of the same concentration with flame working and then placed in an air atmosphere and maintained at 1100° C. for 2 hours and cooled to room temperature for a strain relieving anneal and then it was taken out. (Process b: Flame working treatment process)

On subjecting the ring to surface analysis and bulk analysis after treatment, very high metal impurity concentrations were confirmed. Furthermore, foreign bodies and bubbles were observed in the thickness in the vicinity of the surface. The results are shown in Table 6.

TABLE 6
(Comparative Example 2)

| | | | | | | | | Doped Metal | | |
|---|---|---|---|---|---|---|---|---|---|---|
| | | Metal Impurity | | | | | | Concentration | | |
| | Location of | Concentration (ppb) | | | | | | (ppm) | | Foreign |
| | Analysis | Na | K | Li | Cu | Fe | Ni | Y | Al | Matter |
| Before | Surface - 10 μm | 500 | 500 | 500 | 100 | 500 | 200 | 5000 | 10000 | No |
| Treatment | 10-100 μm | 100 | 100 | 100 | 50 | 200 | 100 | 5000 | 10000 | |
| | Bulk | 100 | 100 | 100 | 50 | 50 | 10 | 5000 | 10000 | |
| After | Surface - 10 μm | 500 | 500 | 500 | 100 | 500 | 200 | 5000 | 10000 | Yes |
| Process b | 10-100 μm | 100 | 100 | 100 | 50 | 200 | 100 | 5000 | 10000 | |
| | Bulk | 100 | 100 | 100 | 50 | 50 | 10 | 5000 | 10000 | |

1. A method for regeneration of a worn quartz glass jig, said method comprising: a purification treatment, a repairing process and a cleaning treatment, wherein during the purification treatment the worn quartz glass jig is subjected to a gaseous atmosphere containing a halogen element at a temperature above a predetermined temperature, and during the repairing process worn parts of the quartz glass jig are repaired, and during the cleaning treatment the repaired quartz glass jig is cleaned, wherein the repairing process includes coating or welding with doped quartz glass material, and wherein at least one treatment selected from the group consisting of fillet welding, attachment of a pre-shaped glass sheet, coating, and flame spray coating is performed, said at least one treatment being followed by a strain-relieving annealing treatment using a flame process.

2. (canceled)

3. (canceled)

4. (canceled)

5. (canceled)

6. A method according to claim 1, wherein from 0.1 to 20 wt % of a metal element is present in the doped quartz glass material.

7. A method according to claim 1, wherein a metal element component is present in the doped quartz glass material, said metal element component, comprising a first metal element selected from group 3B of the periodic table and a type of second metal element selected from among the

8. A method according to claim 1, wherein the cleaning treatment comprises at least one process selected from the group consisting of: heat treatment in a clean atmosphere, heat treatment in a gaseous atmosphere which contains a halogen element, and cleaning by using a cleaning liquid.

9. A method according to claim 1, wherein the purification treatment comprises at least one process selected from the group consisting of: heat treatment in a clean atmosphere, cleaning with cleaning liquids, and removal of material which is attached on a surface of the jig by burning with a flame.

10. A method according to claim 8, wherein the heat treatment in the clean atmosphere is carried out by maintaining the jig at a heating temperature of from 100° C. to 1300° C. in a gaseous atmosphere which contains oxygen for from 1 minute to 400 hours.

11. (canceled)
